(19) United States
(12) Patent Application Publication
(10) Pub. No.: US 2003/0187765 A1
(43) Pub. Date: Oct. 2, 2003

(54) Systems and methods for monitoring credit risk

(75) Inventor: Michael L. Sgaraglio, Massapequa Park, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 10/108,575

(22) Filed: Mar. 27, 2002

(51) Int. Cl. G06F 17/60

(52) U.S. Cl. 705/35

(57) ABSTRACT

Methods and systems for evaluating credit risk are provided. Following underwriting approval, merchants receive credit authorization from a credit issuing entity and initiate operation. Thereafter, circumstances may result in increased credit risk to the credit issuing entity. According to the present invention, the transaction history for each merchant is recorded. Periodically, the transaction history is evaluated for credit risk and merchants may be selected for credit risk review. A merchant is selected from a list of merchants to be reviewed and one or more analyses are performed to evaluate the degree of risk imposed by the merchant. Additional information may also be collected relating to the merchant. Based on the evaluation and the additional information, modifications may be made to the manner in which future credit risk is determined for the merchant. A decision tree may be used to collect the additional information and perform the analyses.

### CROSS-REFERENCES TO RELATED APPLICATIONS

This application is related to commonly assigned and concurrently filed U.S. patent application Ser. No. ______, entitled “DECISION TREE SYSTEMS AND METHODS” (Attorney Docket No. 020375-008200US), by Mark G. Arthus, et al., and to commonly assigned and concurrently filed U.S. patent application Ser. No. ______, entitled “MERCHANT APPLICATION AND UNDERWRITING SYSTEMS AND METHODS” (Attorney Docket No. 020375-007100US), by Michael L. Sgaraglio, et al., and to commonly assigned and concurrently filed U.S. patent application Ser. No. ______, entitled “MERCHANT ACTIVATION TRACKING SYSTEMS AND METHODS” (Attorney Docket No. 020375-023900US), by Michael L. Sgaraglio, et al., and to commonly assigned and concurrently filed U.S. patent application Ser. No. ______, entitled “SYSTEMS AND METHODS FOR MANAGING COLLECTIONS RELATING TO MERCHANT ACCOUNTS” (Attorney Docket No. 020375-008300US), by Mark G. Arthus, et al., and to commonly assigned and concurrently filed U.S. patent application Ser. No. ______, entitled “SYSTEMS AND METHODS TO MONITOR CREDIT FRAUD” (Attorney Docket No. 020375-008400US), by Mark G. Arthus, et al., which applications are incorporated herein by reference in their entirety for all purposes.

### BACKGROUND OF THE INVENTION

This invention relates generally to the field of financial transactions, and in particular to monitoring credit risk associated with credit services between merchants and credit service providers. More specifically, in one aspect the invention relates to periodically reviewing the credit risk associated with merchant accounts by comparing the actual credit risk associated with each account to a relative credit risk for the merchant's industry.

Financial transactions involving the use of presentation instruments, such as credit cards, play an important role in today's economy. A typical credit card transaction proceeds by extracting account information from the credit card, typically using a point of sale device at a merchant location, and submitting the account information along with a requested payment amount to a processing system. Such a processing system may involve the merchant's bank, a credit card association, such as VISA or MasterCard, and the issuer's bank as is known in the art.

Hence, in order to process a credit card transaction, a merchant must typically establish an account with a processing organization. Because the processing organization takes on certain financial risks when agreeing to process a merchant's transactions, an application and underwriting process typically takes place before an account is opened. For example, an account may be established by first requiring the merchant to fill out a credit application. The credit application is then sent to an underwriter who reviews information in the application to determine whether the merchant would be a suitable client. If so, the account is established, and the merchant may begin accepting at least certain types of credit cards as payment for their goods or services.

Thereafter, circumstances may change with respect to the merchant that affect the suitability of the merchant as a client. For example, the merchant's volume of business may increase substantially, the merchant's delivery times for products or services may become extended, the merchant may experience an increased volume of merchandise returns that result in charge backs, and the like. Each of these factors could potentially affect the credit risk to the processing organization. Therefore, processing organizations desire to monitor the account history of their merchant clients.

Hence, there is a need in the art for systems and methods that improve the monitoring of credit risk associated with client accounts.

### BRIEF SUMMARY OF THE INVENTION

Embodiments of the present invention thus provide a method of evaluating the credit risk relating to any of a plurality of merchants. In one such embodiment, financial data relating to the plurality of merchants is received at a server computer. Periodically, a credit risk calculation is performed at the server computer on at least one merchant based on the financial data. One or more merchants are selected for review based on the credit risk calculation. A list of selected merchants in thus compiled. In this way, only certain of the merchants are reviewed in detail, thus increasing the efficiency with which the credit risk assessment process is completed. In one aspect, the financial data may include charges, charge backs and payments. The credit risk calculation may be based on parameters such as the percentage of in-person sales, the number of days from a transaction to the delivery of product or service, and a measure of the consistency with which the delivery of product or service is achieved.

Further embodiments of the present invention include transmitting the list of selected merchants and receiving at the server computer an instruction to transmit the credit risk calculation for a selected merchant. The server computer thereafter transmits the credit risk calculation for the selected merchant.

Another embodiment of the present invention includes receiving additional financial data relating to the selected merchant and storing the additional financial data relating to the selected merchant for future evaluation. The additional financial data may include, for example, the merchants credit rating from a credit rating service.

Yet another embodiment includes receiving an instruction to alter at least one parameter of the credit risk calculation relating to the selected merchant and performing a revised credit risk calculation for the selected merchant. The embodiment also includes receiving an instruction to save the altered at least one parameter relating to the selected merchant and storing the altered parameter relating to the merchant for future evaluation.

Another embodiment includes receiving an instruction to generate a report relating to the credit risk of a plurality of merchants and transmitting the report to a remote computer. The report may include top gross risk by industry, top gross risk by rating, restricted SIC detail, restricted SIC summary, unqualified SIC detail, unqualified SIC summary, changes report and classified report.

Yet another embodiment includes performing an aggregate credit risk calculation relating to a group of merchants. The embodiment may include receiving an instruction to generate a report relating to the aggregate credit risk calculation and transmitting the report to a remote computer.

Embodiments of the invention also include using a decision tree to review merchant accounts selected for further review. The decision tree permits credit risk evaluations to be performed using less skilled employees by forcing the evaluation process to follow an ordered path.

An embodiment of the present invention includes a system for evaluating the credit risk relating to any of a plurality of merchants. The system includes a server computer that is adapted to be coupled to a network. The server computer has an interface that is adapted to receive incoming data signals and to transmit outgoing data signals. The system also includes a database associated with the server computer. The database has financial data relating to the plurality of merchants. The server computer is configured to receive financial data for at least one merchant and perform a credit risk calculation on the merchant based on the financial data. The server computer is further configured to select at least one merchant for review based on the credit risk calculation. The server is further configured to compile a list of selected merchants.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a schematic representation of a computer system that may be configured to implement methods of the present invention;

FIG. 2 illustrates a flow diagram illustrating an embodiment of the present invention;

FIGS. 3a and b illustrate top and bottom portions, respectively, of a query screen display for selecting merchant accounts for review in accordance with an embodiment of the present invention;

FIGS. 4a and b illustrate top and bottom portions, respectively, of a merchant review display screen according to an embodiment of the present invention;

FIG. 5 illustrates a “what-if” analysis display screen according to an embodiment of the present invention;

FIG. 6 illustrates a “what-if” results display screen according to an embodiment of the present invention;

FIG. 7 illustrates a second merchant review display screen according to an embodiment of the present invention;

FIG. 8 illustrates a reports menu display screen according to an embodiment of the present invention; and

FIG. 9 illustrates a hierarchy creation display screen according to an embodiment of the present invention.

### DETAILED DESCRIPTION OF THE INVENTION

Embodiments of the present invention provide systems and methods for credit issuers to monitor their ongoing exposure to risk associated with credit services. This detailed description presents the invention in a non-limiting example relating to credit card processing organizations. Throughout this description, reference is made to certain well known systems, products and processes, such as, for example, the Internet, web sites, web site browsers, databases, and the like, which will not be described in detail in order not to unnecessarily obscure the present invention. In light of this detailed description, those skilled in the art will realize how to make and use the present invention in a number of different embodiments using a range of equivalents to elements discussed herein, all of which are within the scope of the present invention as defined by the claims that follow.

Credit services may be established with essentially any type of person, entity, organization, business, or the like that wishes to take payments for goods or services in the form of a credit, and, for convenience of discussion, are generally referred to herein as “merchants”. Such merchants may process a credit transaction based on an account identifier presented at the time of payment. The account identifier is used to identify the account to which the credit will eventually be posted. In many cases, the account identifier is provided on some type of presentation instrument, such as a credit card, debit card, smart card, stored value card, or the like. Conveniently, the account identifier may be read from a point of sale device, such as those described in copending U.S. application Ser. Nos. 09/634,901, entitled “POINT OF SALE PAYMENT SYSTEM,” filed Aug. 9, 2000 by Randy J. Templeton et al., which is a nonprovisional of U.S. Prov. Appl. No. 60/147,899, entitled “INTEGRATED POINT OF SALE DEVICE,” filed Aug. 9, 1999 by Randy Templeton et al, the complete disclosures of which are herein incorporated by reference. However, the account identifier may be obtained in other ways, such as by visual inspection of the presentation instrument, by telephone, over the Internet, and the like.

The user account information is transmitted to a credit processing service that approves and processes the transaction information and provides payment to the merchant. As is known, various other organizations may also participate in the transaction in order to bill the user for the transaction, including the issuing bank, the merchant's bank, a credit card association, and the like. The credit processing service may also handle “charge backs”, e.g. when the card holder requests a refund and the account is credited. One example of a credit processing service is the service provided by First Data Corporation, Greenwood Village, Colo.

Systems and methods for establishing and maintaining merchant accounts are more fully explained in previously incorporated U.S. patent application Ser. No. ______, entitled “MERCHANT APPLICATION AND UNDERWRITING SYSTEMS AND METHODS” and in previously incorporated U.S. patent application Ser. No. ______, entitled “MERCHANT ACTIVATION TRACKING SYSTEMS AND METHODS”. Because credit processing organizations assume a certain degree of credit risk by accepting a merchant as a client, the application process includes an underwriting process wherein the credit processing organization estimates the degree of credit risk exposure.

Credit risk exposure may result from a number of factors. For example, the method by which a merchant obtains a customer's account number may introduce a degree of exposure. In-person sales using a point of sale device generally introduce less risk than other transaction methods. This is so for a variety of reasons, including, for example: the merchant is able to verify certain information about the customer presenting the credit card as payment; the transaction is posted immediately; and the customer acknowledges the transaction by signing a receipt. On the other hand, mail order and telephone order transactions, wherein account information is given over the phone or through the mail, eliminate many of the safeguards inherent to in-person transactions. This is also the case with Internet sales. Thus, the credit card processing organization may become exposed to greater risk, especially between the time that the merchant is paid and the time that payment is received from the customer.

Another factor that may affect credit risk exposure is the number of days between the transaction and the delivery of the product or service. For example, a merchant who accepts credit card payments for meals at a restaurant does not generate the degree of credit risk as does a merchant providing travel services booked months in advance. The risk varies as well in relationship to the frequency with which a merchant delivers a product or service according to a particular delivery schedule considered to be an industry average.

One method for categorizing merchants according to credit risk is by industry. Using the well know SIC code system, or Standardized Industrial Classification code system, credit processing organizations may compare merchants with other merchants according to their SIC code. Because merchants within a particular SIC code tend to have similar percentages of mail order and telephone order sales and similar delivery times and patterns, the credit risk associated with merchants in a particular SIC code tends to be similar. Thus, credit processing organizations use industry-specific criteria in the credit underwriting process.

Once a merchant is accepted as a client and the merchant begins accepting credit cards and other presentation instruments for payment, a credit processing organization may choose to monitor the activities of the merchant with respect to the transactions within which the merchant participates. The transactions may include both sales of goods and services and credits for goods and services returned or refused. The transactions may also include payments by the credit processing organization to the merchant. For convenience, sales and returns will be referred to herein as “charges” and “charge backs”. The volume of business a merchant processes in the way of charges, the percentage of charge backs, the percentage of in-person sales, and the product or service delivery schedule all warrant monitoring to ensure that a merchant does not become an excessive credit risk. Thus, the present invention provides systems and methods for more efficiently monitoring credit risk by tacking and analyzing this financial data associated with merchant-customers.

According to the present invention, financial data, including merchant transaction information, is recorded over time for the merchants doing business with the credit processing organization. Periodically, the transaction history is used to calculate the credit risk for each merchant using criteria appropriate for the merchant. The criteria may be based on the merchant's SIC code and may include transaction history such as charge and charge back volume, and the like. Based on the periodic review, some merchants may be flagged for credit review. Other events may trigger review flags, such as scheduled reviews, new merchant accounts, and the like. The review triggers may be customized according to the needs of the credit issuing entity. Thus, the present invention periodically, through an automated process, produces a list of merchant accounts to be reviewed.

From the review list, analysts may select merchants accounts to be reviewed. The evaluation may include “what if” scenarios to determine, for example, the sensitivity of the calculated credit risk to certain parameters, such as, for example, percentage of in-person sales, delivery time and pattern. The analysts may adjust parameters used in the automated process of calculating credit risk, if, for instance, the standard parameters of the merchant's industry are not appropriate for the merchant. The analyst may place the merchant in a “watch” category, which would result in the merchant being flagged for review in a future time period, even if the credit risk calculated for the future time period does not trigger a review. The analyst may also pass the merchant information, including any information developed or collected by the analyst, to other analysts who specialize in, for example, fraud investigation and collection management. Systems and methods for investigating suspected fraud with respect to merchant accounts are more fully explained in previously incorporated U.S. patent application Ser. No. ______, entitled “SYSTEMS AND METHODS TO MONITOR CREDIT FRAUD”. Systems and methods for managing collections issues with respect to merchant accounts are more fully explained in previously incorporated U.S. patent application Ser. No. ______, entitled “SYSTEMS AND METHODS FOR MANAGING COLLECTIONS RELATING TO MERCHANT ACCOUNTS”.

The present invention also provides a significant reporting capability. Reports may be generated for a variety of reasons. For example, reports may provide insight into the total credit risk exposure of the credit issuing entity. The reports may be segregated according to industry, credit-worthiness and the like. Reports may also track the progress of analysts reviewing merchant accounts. Reports may also enumerate changes made by analysts to the criteria used to calculate credit risk for merchants. Thus, management is provided with a number of useful reports for evaluating the businesses exposure and the performance of its employees.

One convenient feature provided by the present invention is the ability to group or ungroup merchants according to certain relationships. For example, a merchant having many outlets may be evaluated by outlet, rather than by the combined business, or a number of merchants representing a chain or other relationship may be grouped together for combined analysis. This feature allows the credit processing organization to more accurately assess the credit risk associated with related businesses.

Another feature provided by the present invention is the ability to operate the credit evaluation system across a network such as the Internet. For example, the recording of merchant transactions and the periodic risk calculations may be performed at a server computer. The review list may be transmitted to one or more analysts' computers, which may also be used by the analysts to access merchant information from the server computer. A web site browser environment may be used to interact with the server computer in a manner well known to those skilled in the art. For example, managers may access reports from locations different from the location of the server computer or any analysts' computers.

The process by which an analyst goes about reviewing merchants' accounts may be further facilitated through the use of a decision tree. Decision trees are more fully explained in previously incorporated U.S. patent application Ser. No. ______, entitled “DECISION TREE SYSTEMS AND METHODS”. Thus, the credit processing organization may substantially reduce the cost of labor for monitoring credit risk by employing less skilled administrative personnel to accomplish tasks typically reserved to analysts.

Having described the present invention generally, the invention will be described in more detail using a specific, non-limiting example. Although the examples herein relate to credit processing organizations, the present invention is in no way limited by these examples.

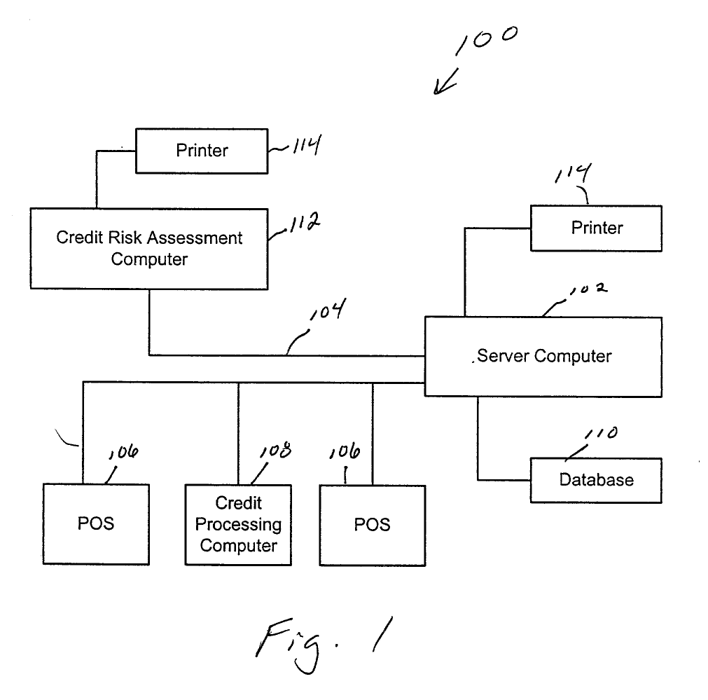

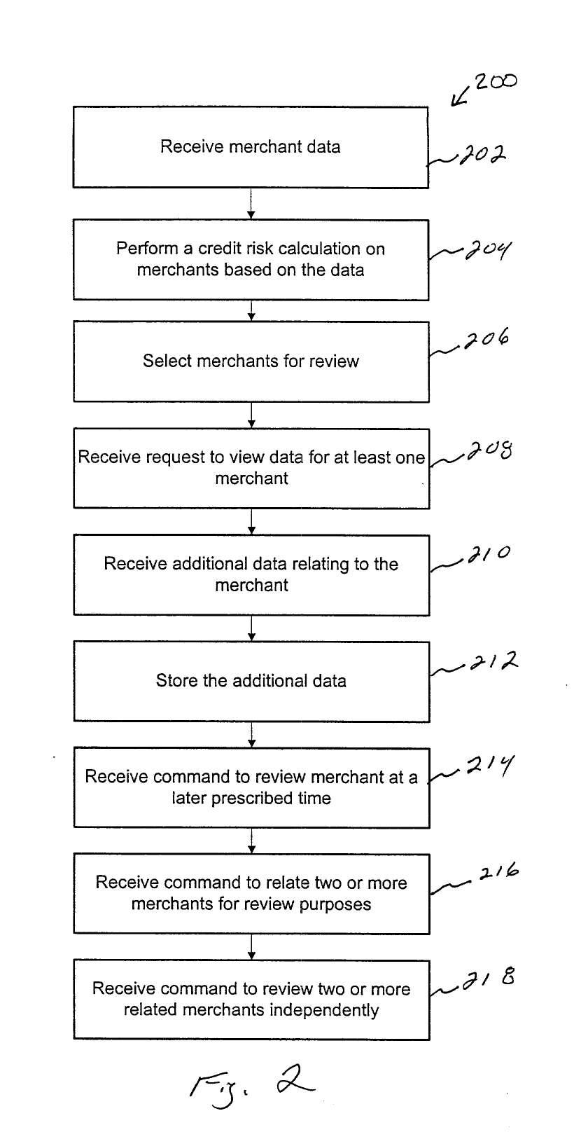

Referring to FIG. 1, a first embodiment of a system 100 for monitoring credit risk is illustrated. The system 100 includes a server computer 102 connected to a network 104. The server computer 102 may be any of a number of computing devices known to those skilled in the are, such as, for example, a personal computer, a workstation, or the like. Application programs residing on the server computer 102 allow the server computer to send and receive files from other computing devices. A suitable interface, as is known in the art, allows the server computer 102 to communicate with other devices via the network 104. The network 104 may be, for example, a wide area network, a local area network, the Internet, or the like.

The server computer 102 is configured to receive merchant credit transaction information from one or more point of sale deices 106 or credit processing computers 108. The server computer 102 causes the transaction information to be stored on a data storage arrangement. The data storage arrangement, or database 110, may be any one or a combination of well known types of recording media, including, for example, magnetic tape, disk drives, optical storage systems and the like. The database 110 may be integral to the server computer 102 or located elsewhere such that the server computer 102 accesses the database 110 via a network.

Through the network 104, the server computer 102 is able to exchange information with one or more credit risk assessment computers 112. For example, the server computer 102 periodically generates a list of merchants whose credit risk should be reviewed and transmits the list to the credit risk assessment computer 112. A user, such as an analyst, at the credit risk assessment computer 112 may develop information relating to a merchant's credit risk and transmit the information to the server computer 102 for storage in the database 110. The server computer 102 may also respond to commands from the credit risk assessment computer 112 to generate one or more reports, which the server computer 102 transmits to the credit risk assessment computer 112. Thereafter, the credit risk assessment computer 112 may respond to commands from a user to output the report on, for example, a printer 114.

The server computer 102 and/or the credit risk assessment computer 112 may be configured more specifically to perform the methods of the present invention and employ the graphical user interface to be described hereinafter. It merits noting that in some embodiments of the present invention, the server computer 102, the credit risk assessment computer 112 and the database 110 exist together in a single computing device.

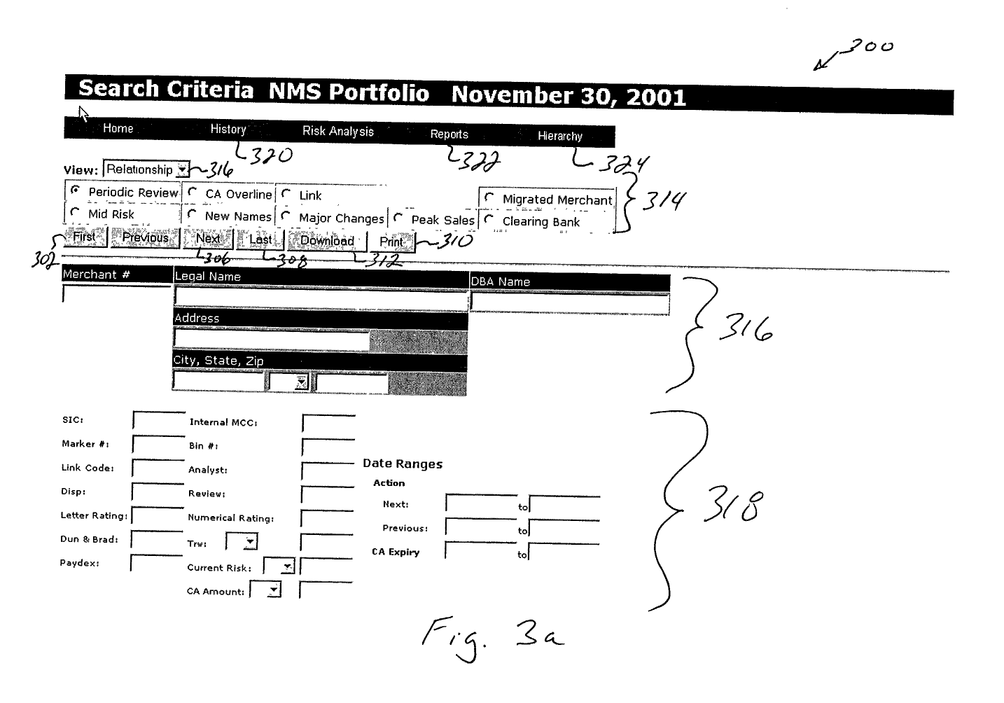

Referring to FIG. 2, a first embodiment of a method 200 of monitoring credit risk according to the present invention is illustrated. At operation 202, merchant data is received and stored. The merchant data may include financial data and transaction data. Examples include changes, charge backs, payments to merchants, each merchant's SIC code, information from the underwriting process for each merchant, the percentage of the merchants' sales that are in person, and the like.

At operation 204, a credit risk calculation is performed on merchants doing business with the credit processing organization based on the merchant data. The operation 204 may be performed, for example, periodically and automatically by a server computer such as the server computer 102 of FIG. 1. Alternatively, the operation 204 may be initiated manually by, for example, a credit risk analyst. The calculation also may be performed on groups of related merchants. The calculation may consider a merchant's industry, as indicated by the merchant's code. Past experience with the merchant may also be used in the calculation. Many other factors may be included, the specific formula being customizable, depending upon the needs of the credit issuing entity.

At operation 206, merchants are selected for credit risk review by, for example, the computer that performs the credit risk calculation. Merchants may be selected based on the credit risk calculation and other factors. For example, merchants may have been identified in prior review periods for later review irrespective of the credit risk calculation. Merchants also may be selected for review during the first period or an early period in which the merchant is doing business with the credit processing organization. Merchants may be reviewed because certain parameters such as sales volume or charge back volume increases or decreases substantially with respect to prior periods. Other reasons for selecting merchants for review may be established based on the specific needs and circumstances of the credit processing organization.

Once a list is generated of merchants whose credit risk should be reviewed, a request to review the data associated with one or more merchants may be received at operation 208, in response to which, the information may be transmitted. The request may originate at a credit risk assessment computer, for example, when an analyst begins reviewing the merchant accounts selected for review during a particular review period.

At operation 210, additional data relating to the merchant may be received. For example, information may be received relating to altered parameters to be used in calculating the credit risk associated with a merchant. During review of a merchant's account, an analyst may discover that a merchant is following acceptable business practices that happen to be non-standard for the merchant's industry. Thus, the analyst may adjust factors used to calculate the credit risk associated with the merchant. The operation 210 may include a series of “what-if” analyses by an analyst to select optimum, or at least improved, parameters to be used for the merchant. Other relevant information may be received, depending on the needs and circumstances of the credit processing organization. For example, the additional information may include instructions to transmit the merchant data to a collections management organization or a fraud investigations organization. The additional information may also include instructions to cause the merchant to be reviewed in a subsequent period. In summary, the additional data received during the operation 210 is directed toward preventing the selection for review (operation 206) in future review periods of merchant's generating acceptable risk exposure to the credit issuing entity. The additional information may be stored, as indicated at operation 212.

At operation 214, one or more commands may be received to generate reports related to a merchant or a group of merchants, in response to which the reports may be transmitted via a network to a remote location or viewed or printed locally. The reports may 25 include credit risk information by industry, by merchant, by rating and the like. Reports may cover a defined period of time or the current period. Additionally, merchants whose credit should have been reviewed during a period but was not may be reported. Many different types of reports may be available, depending on the particular needs and circumstances of the credit issuing entity.

At operation 216, instructions to related two or more merchants for credit risk monitoring purposes may be received. Thereafter, periodic credit risk calculations may be performed on the related merchants as a group. For example, a group of merchants may be doing business under different names; however, the merchants may function, in a business sense, as a common entity. This might be the case for chains. The credit issuing entity may be subjected to unacceptable risk based on the group as a whole, while the individual entities might all present acceptable risk. Thus, it benefits the credit issuing organization to treat the group as a unit for analysis purposes.

At operation 218, instructions may be received to evaluate related merchants individually, such as may be the case for merchants having an outlet that is typically evaluated together with the parent organization. Thereafter, the parent and outlet may be evaluated separately. This represents a converse situation to that associated with chains. Herein, a single entity may present acceptable risk, while a subset of the entity, such as an outlet, may present unacceptably high levels of credit risk, the fact going unnoticed at the operation 206. Thus, the present invention provides the ability to evaluate such related merchants individually.

Having described systems and methods according to the present invention, further details of the present invention will be described more fully through a specific non-limiting example of one embodiment of the present invention. This particular embodiment makes use of a web site browser environment as a user interface. The web site pages may be generated, for example, at a server computer such as the server computer 102 of FIG. 1, and transmitted for display at credit risk assessment computers, such as the one also illustrated in FIG. 1 and identified by reference numeral 212.

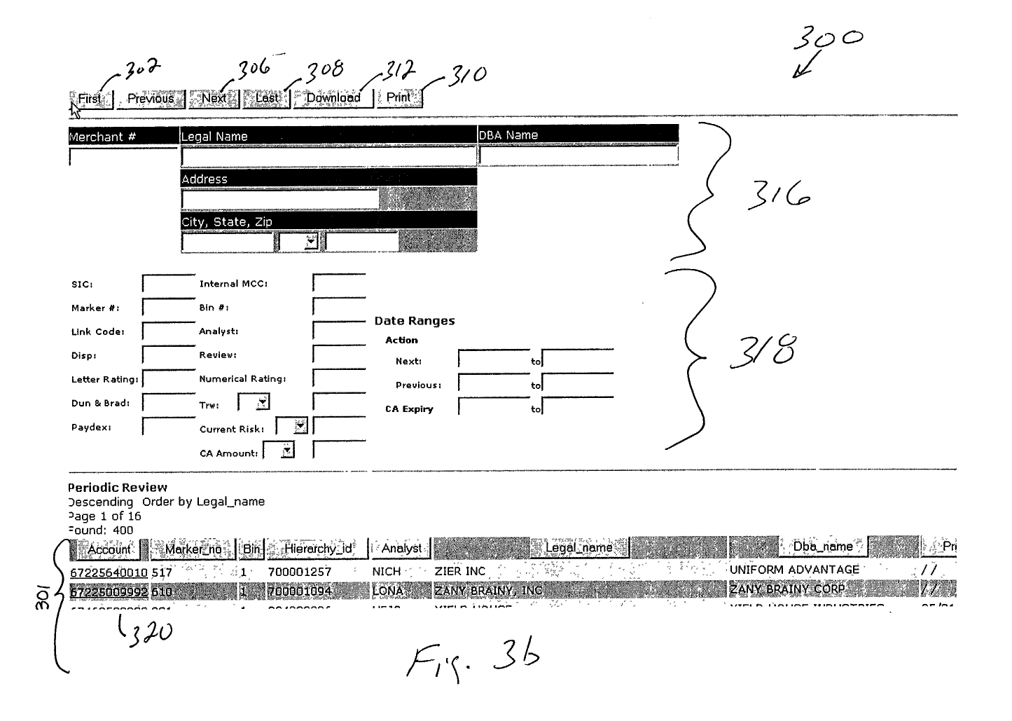

FIGS. 3a and b illustrate top and bottom portions, respectively, of a first display screen 300 for searching a list of merchants for whom credit risk is to be reviewed. This query display screen might be used by an analyst initiating the review process discussed in relation to operation 208 of FIG. 2. Thus, at the point in time that the display screen 300 is presented, a list of merchants typically would have been identified for review. As mentioned previously, the present invention may take place via the Internet in a web browser graphical environment. Thus, an embodiment of the present invention includes a security feature to prevent unauthorized access to the information obtainable through the display screen 300.

The display screen 300 is a category query screen for selecting merchants according to certain criteria in various categories. It may be the case that the list of merchants 301 to be reviewed is partitioned into groups, with each group being assigned to one analyst for review. Thus, the group of merchants accessible via this display screen 300 may represent only a subset of the total list selected for review.

The display screen includes a number of navigation icons familiar to those skilled in the art. For example, first 302, previous 304, next 306 and last 308 ions navigate to the respective page of the list 301 of merchants selected for review. A print icon 310 causes the current merchant data and/or current list to be printed. A download icon 312 produces a list of only those merchants meeting the criteria selected, as will be explained immediately hereinafter.

A list partitioning section 314 contains a number of possibilities for subdividing the list of merchants 301 into smaller, related classes. For example, a “View” drop down menu 316 partitions the list 301 according to merchants related, for example, as chains or outlets. Other options allow the merchants to be grouped according to the reason the merchants were selected for review. Reasons include: credit risk above specified thresholds; credit risk exceeding underwriting estimates; new merchants; major variations in sales or other risk parameters; merchants whose volume has decreased so as to indicate the possibility the merchant may leave or “migrate” to another processing organization; and issues associated with the clearing bank through which the merchant is transacting business. Merchants may be further segmented into classifications, such as, for example, a periodic review list, including merchants with evaluated risk above $150,000 and a mid risk list, including merchants with risk from $20,000 to $149,999.99. A merchant specific section 316 allows merchants to be selected from the list based on typically unique identifiers, such as name, address and account number. A category section 318 allows merchants to be selected from the list by specified criteria. Such criteria include: SIC code; credit rating; variation from underwriting credit risk; total current risk; and many other factors. Once the user selects criteria by which to partition the list of merchants 301, the user may select the download icon 312 to update the display screen accordingly.

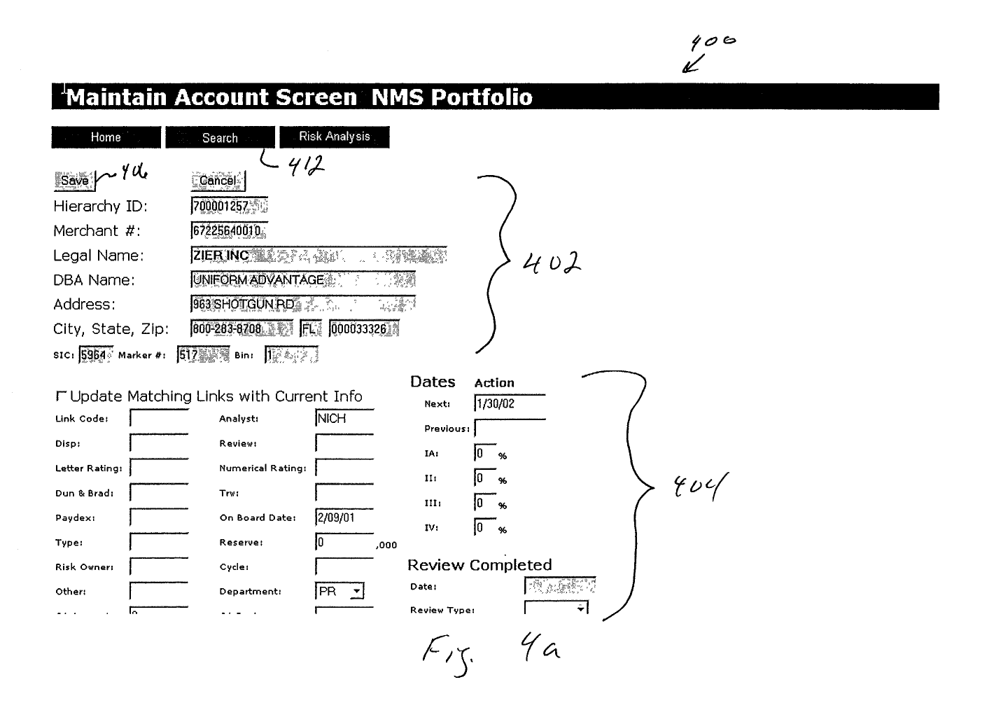

The list of merchants 301 includes a number of data fields helpful to the analyst in conducting credit risk evaluations. However, in order to obtain even more detailed information, the analyst may “drill down” into specific data related to a particular merchant by selecting the account number 320 for a merchant, which functions as a hyperlink to the display screen illustrated in FIGS. 4a and b. Other icons shown in FIGS. 3a and b will be discussed in more detail hereinafter.

FIGS. 4a and b are top and bottom portions, respectively, of a merchant data display screen 400. The screen includes several sections for reviewing and entering data relating to a particular merchant. A merchant specific section 402 includes typically unique identification information relating to the merchant. As a feature, the data fields in this section 402 may be configured such that the data cannot be changed. A credit data section 404 includes a number of data fields for entering information relating to the current or previous credit risk reviews of the merchant. The analyst may update this information by entering new data and selecting the save icon 406. Conveniently, the data may be updated in the course of reviewing the merchant's account through the use of a decision tree, as described in more detail in previously incorporated U.S. patent application Ser. No. ______, entitled “DECISION TREE SYSTEMS AND METHODS”.

A credit risk section 408 lists the present and historical credit risk for the merchant, as well as factors (e.g., sales, credits and charge backs) that may contribute to the credit risk. Thus, an analyst is able to view the current risk in historical context and potentially determine what factors may be most responsible for triggering the review. A comments section 410 is also available for entering notes relating to the review. By selecting the search icon 412, an analyst may be taken to a “what if” display screen for performing more detailed analyses.

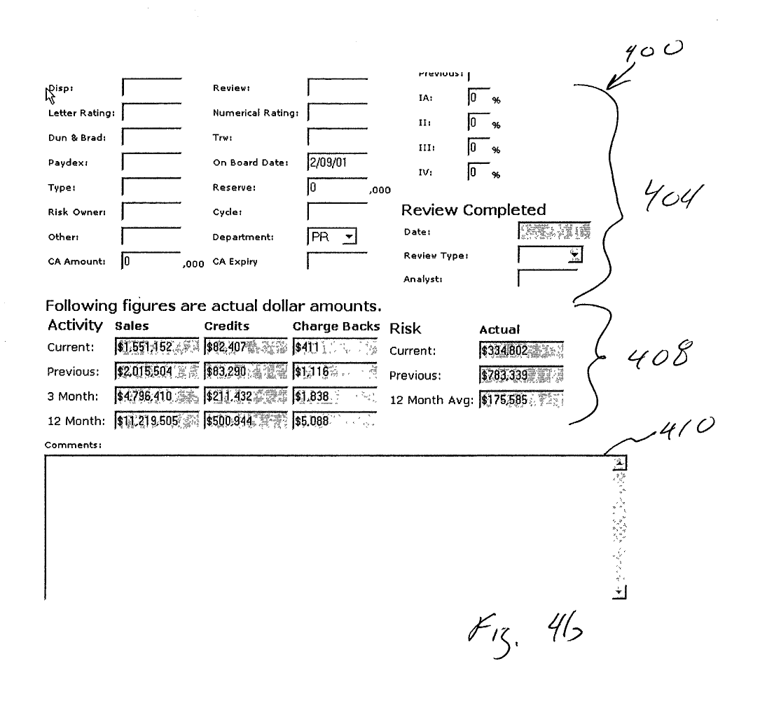

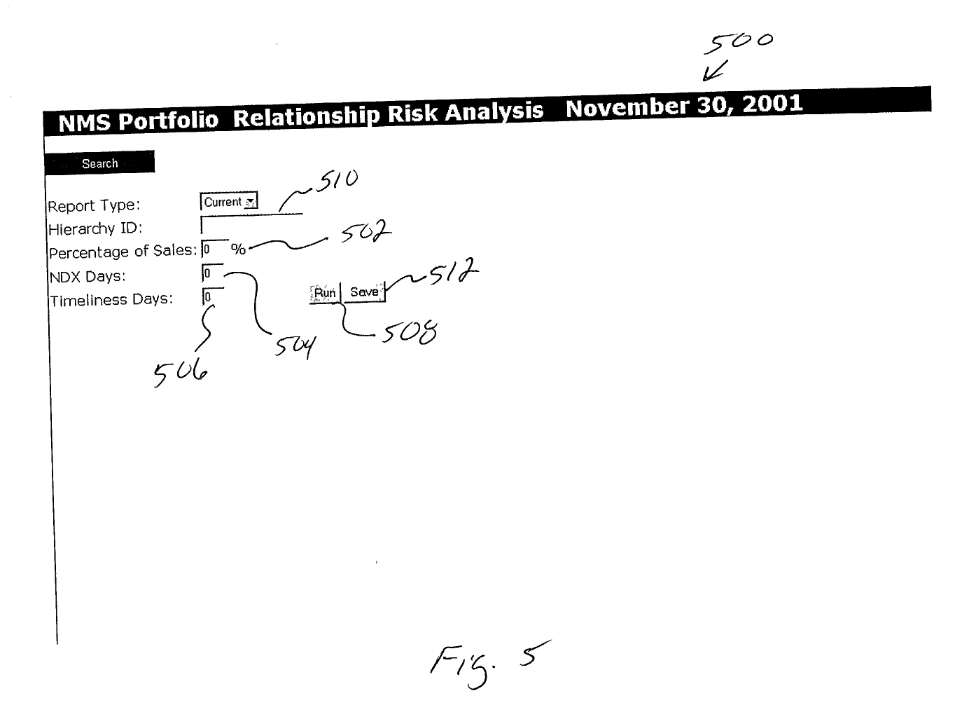

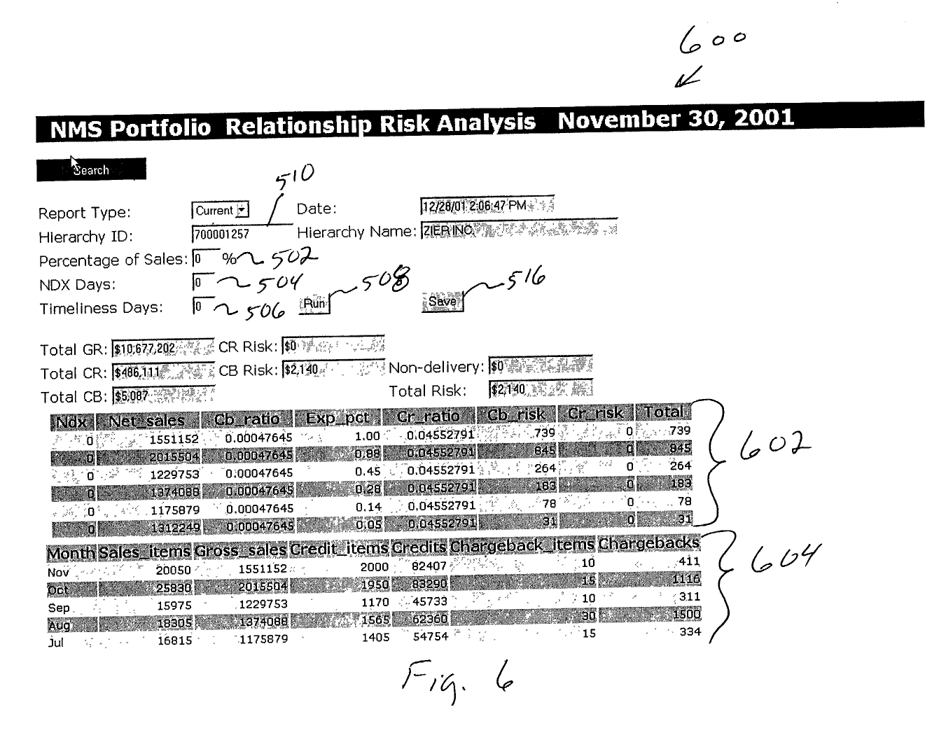

FIG. 5 illustrates the “what if” display screen 500, through which an analyst may alter parameters that contribute to a merchant's credit risk. For example, the analyst may change the percentage of sales factor 502 that represents the portion of the merchant's sales that are in-person, vice telephone, mail order or Internet. An analyst may also change the delivery days factor 504 and/or the timeliness of delivery factor 506. Each of the factors 502, 504, 506 may be set initially at industry standard levels and thereafter be adjusted to reflect non-standard experience by the merchant. After changing the factors, an analyst may select the run icon 508 to display the revised credit risk for the merchant, as shown in a “what if” results display screen 600 of FIG. 6.

The display screen 600 of FIG. 6 illustrates the results of a “what-if” analyses performed using the display screen 500 of FIG. 5. It includes are revised credit risk area 602 and a historical credit risk area 604. Thus, this display screen presents an analyst with various information for refining the parameters used to calculate credit risk for a merchant. The display screen 600 also provides fields 502, 504, 506 for revising the parameters and a run icon 508 for initiating a revised “what-if” analysis.

Conveniently, in one embodiment the analyses performed through the use of the display screens 500, 600 of FIGS. 5 and 6 may be performed on related merchants through the use of the hierarchy data field 510. From either of the display screens 500, 600, an analyst may save the adjustments by selecting the save icon 512.

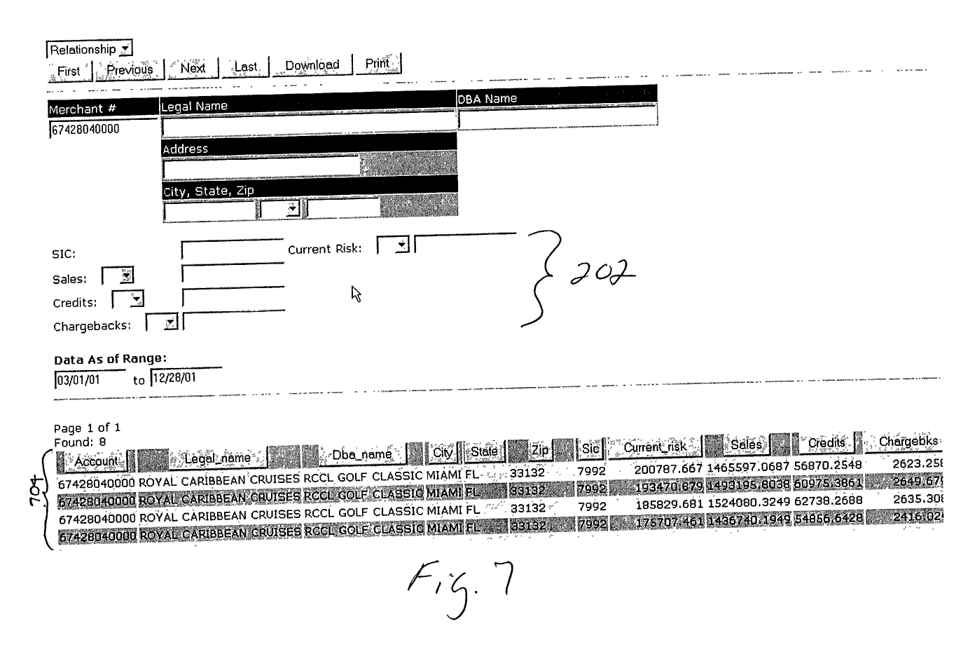

Referring back to FIG. 3a, the functions of the history icon 320, the reports icon 322 and the hierarchy icon 324 will be described. The history icon 320 provides the ability to perform similar analyses as those described heretofore. Analysts are not limited to performing reviews on only merchants selected for review. For various reasons, an analyst may determine that a review of a non-selected merchant account is warranted. Thus, through the use of the history icon 320, merchants may be reviewed that were not in the list selected for review. Otherwise, the process is substantially similar. Selecting the history icon 320 results in the rendering of the history data screen 700 of FIG. 7.

The history data screen 700 is illustrated in FIG. 7. Through the history data screen 700, merchants, including those not selected for review, may be reviewed according to a number of different parameters 702. The merchants matching the parameters 702 appear in a list 704.

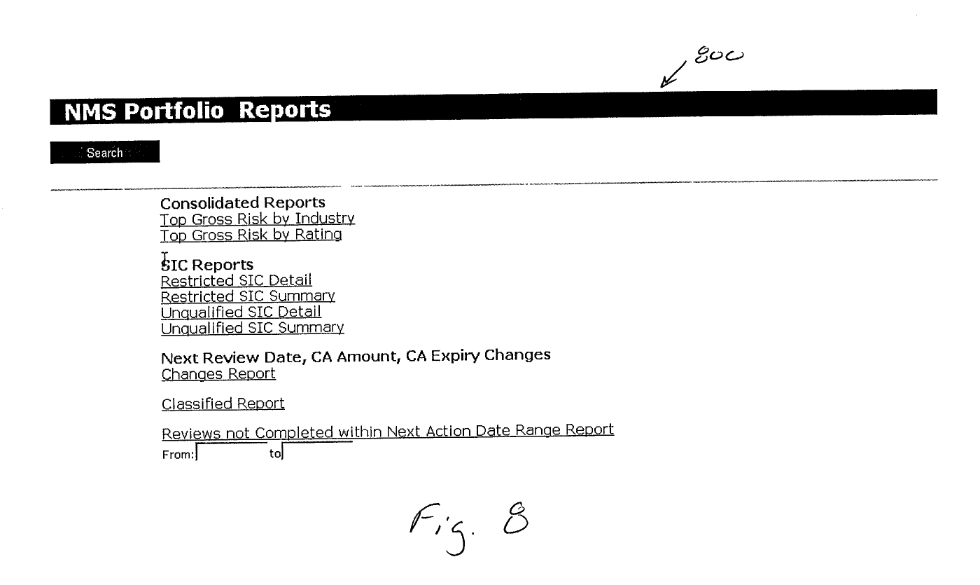

The reports icon 322 provides for the creation of many types of reports relevant to the credit risk evaluation process. A reports display screen 800 is illustrated in FIG. 8. Reports may include top gross risk by industry, top gross risk by rating, restricted SIC detail, restricted SIC summary, unqualified SIC detail, unqualified SIC summary, changes report and classified report. Many other report types are possible.

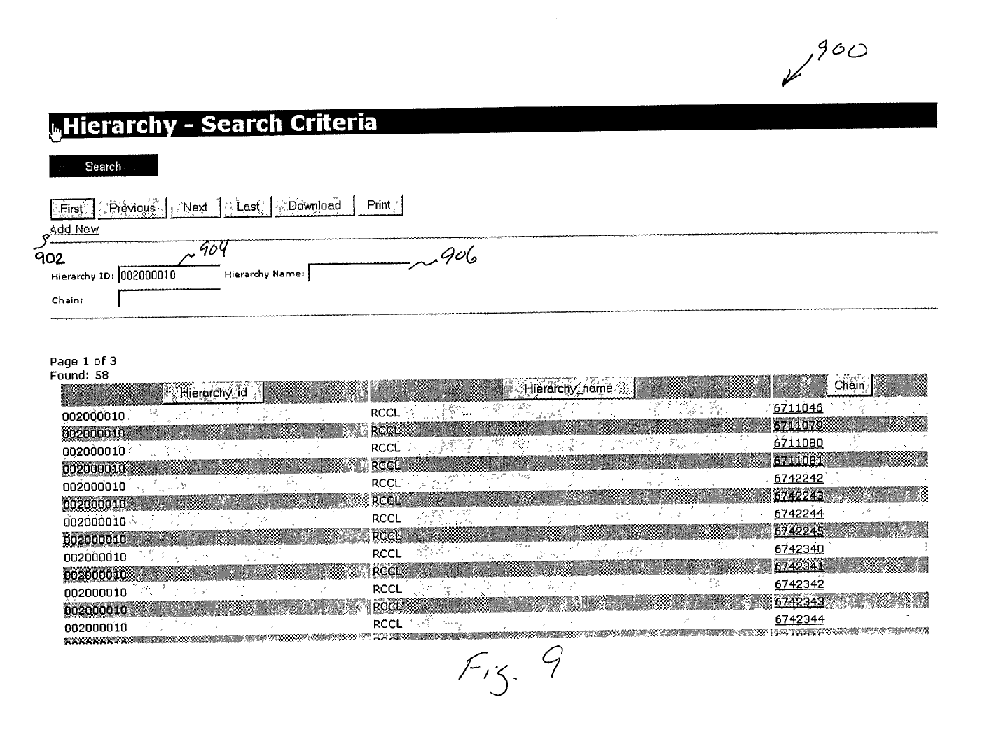

The hierarchy icon 324 of FIG. 3 takes the analyst to the hierarchy display screen 900, illustrated in FIG. 9. The hierarchy display screen 900 provides for the creation of groups of related merchants. By selecting the “add new” icon 902, merchants may be added to a group. By entering a hierarchy ID number in the data field 904, the merchants included in a particular group may be viewed. The hierarchy may be named by entering a name in the data field 906.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers through the use of web-browser software. Accordingly, the above description should not be taken as limiting the scope of the invention, which is defined in the following claims.

What is claimed is:

1. A method of evaluating the credit risk relating to any of a plurality of merchants, comprising:
receiving at a server computer financial data relating to the plurality of merchants;
periodically performing a credit risk calculation on at least one merchant based on the financial data received at the server computer;
selecting at least one merchant for review based on the credit risk calculation; and
compiling a list of selected merchants.

2. The method of claim 1, further comprising:
receiving at the server computer an instruction to transmit the list of selected merchants;
transmitting the list;
receiving at the server computer an instruction to transmit the credit risk calculation for a selected one of the merchants; and
transmitting the credit risk calculation for the selected merchant.

3. The method of claim 2, further comprising:
receiving additional financial data relating to the selected merchant; and
storing the additional financial data relating to the selected merchant for future evaluation.

4. The method of claim 2, further comprising:
receiving an instruction to alter at least one parameter of the credit risk calculation relating to the selected merchant;
performing a revised credit risk calculation for the selected merchant;
receiving an instruction to save the altered at least one parameter relating to the selected merchant; and
storing the altered at least one parameter relating to the merchant for future evaluation.

5. The method of claim 1, further comprising:
receiving an instruction to generate a report relating to the credit risk of a plurality of merchants; and
transmitting the report to a remote computer.

6. The method of claim 1, further comprising:
performing an aggregate credit risk calculation relating to a group of the merchants;
receiving an instruction to generate a report relating to the aggregate credit risk calculation; and
transmitting the report to a remote computer.

7. The method of claim 1, wherein the financial data is selected from the group consisting of charges, charge backs and payments.

8. The method of claim 1, wherein the credit risk calculation uses parameters selected from the group consisting of the percentage of in-person sales as compared to an industry average, the number of days from a transaction to the delivery of product or service as compared to an industry average, and a measure of the consistency with which the delivery of product or service is achieved as compared to an industry average.

9. The method of claim 5, wherein the report is selected from the group consisting of top gross risk by industry, top gross risk by rating, restricted standard industrial classification (SIC) code detail, restricted SIC code summary, unqualified SIC code detail, unqualified SIC code summary, changes report and classified report.

10. The method of claim 2 further comprising:
receiving an instruction to initiate a decision tree to facilitate the review of the selected merchant; and
transmitting a document containing the decision tree.

11. A system for evaluating the credit risk relating to any of a plurality of merchants, comprising:
a server computer that is adapted to be coupled to a network, the server computer having an interface that is adapted to receive incoming data signals and to transmit outgoing data signals; and
a database associated with the server computer, the database having financial data relating to the plurality of merchants;
wherein the server computer is configured to receive financial data for the plurality of merchants and perform a credit risk calculation on the plurality of merchants based on the financial data, wherein the server computer is further configured to select at least one merchant for review based on the credit risk calculation, and wherein the server is configured to compile a list of selected merchants.

12. The system of claim 11, wherein the server computer is further configured to receive an instruction to transmit the list of selected merchants and to transmit the list according to the instruction, and wherein the server computer is configured to receive an instruction to transmit the credit risk calculation for a selected merchant and to transmit the credit risk calculation for the selected merchant according to the instruction.

13. The system of claim 12, wherein the server computer is further configured to receive additional financial data relating to the selected merchant and store the additional financial data relating to the selected merchant for future evaluation.

14. The system of claim 12, wherein the server computer is further configured to receive an instruction to alter at least one parameter of the credit risk calculation relating to the selected merchant and perform a revised credit risk calculation for the selected merchant, and wherein the server computer is configured to receive an instruction to save the altered parameter relating to the selected merchant and store the altered parameter relating to the merchant for future evaluation.

15. The system of claim 11, wherein the server computer is further configured to receive an instruction to generate a report relating to the credit risk of a plurality of merchants and transmit the report to a remote computer.

16. The system of claim 11, wherein the server computer is further configured to perform an aggregate credit risk calculation relating to a group of merchants, receive an instruction to generate a report relating to the aggregate credit risk calculation and transmit the report to a remote computer.

17. The system of claim 11, wherein the financial data is selected from the group consisting of charges, charge backs and payments.

18. The system of claim 11, wherein the credit risk calculation includes parameters selected from the group consisting of the percentage of in-person sales as compared to an industry average, the number of days from a transaction to the delivery of product or service as compared to an industry average, and a measure of the consistency with which the delivery of product or service is achieved as compared to an industry average.

19. The system of claim 15, wherein the report is selected from the group consisting of top gross risk by industry, top gross risk by rating, restricted standard industrialization classification (SIC) code detail, restricted SIC code summary, unqualified SIC code detail, unqualified SIC code summary, changes report and classified report.

20. The system of claim 12, wherein the server computer is further configured to receive an instruction to initiate a decision tree to facilitate the review of the selected merchant and transmit a document containing the decision tree.
